(19) United States
(12) Patent Application Publication
(10) Pub. No.: US 2024/0049653 A1
(43) Pub. Date: Feb. 15, 2024

(54) SOLID STATE EMITTER GROW LIGHTING SYSTEM

(71) Applicant: American Machine Vision LLC, Sandown, NH (US)

(72) Inventors: Brian C. Sanders, Salem, NH (US); Frederick A. Wright, Manchester, NH (US)

(21) Appl. No.: 18/225,997

(22) Filed: Jul. 25, 2023

Related U.S. Application Data
(60) Provisional application No. 63/392,608, filed on Jul. 27, 2022.

(51) Int. Cl. A01G 9/24; F21S 2/00; F21V 23/00

(52) U.S. Cl. CPC A01G 9/249; F21S 2/005; F21V 23/005; F21Y 2115/10

(57) ABSTRACT

A solid-state emitter grow light assembly comprises a main housing, configured for providing secure attachment and positioning of one or more individual modular array strips. A plurality of emitter arrays are each configured for mounting to an individual modular array strip. Each of the plurality of emitter arrays including a plurality of solid-state emitters mounted on a printed circuit board. The solid-state emitters are user selectable to emit light of a desired color spectrum. A plurality of pushed pin fasteners secure each emitter array to a modular array strip and each modular array strip to said Main housing. A plurality of driver modules are coupled to and configured for energizing one or more of the solid State emitters.

### CROSS-REFERENCE TO RELATED APPLICATION

This application claims priority from U.S. provisional patent application No. 63/392,608 filed on Jul. 27, 2022 entitled “SOLID STATE EMITTER GROW LIGHTING SYSTEM” which is incorporated fully herein by reference.

### TECHNICAL FIELD

The present invention relates to grow light systems and more particularly, to a solid state, LED grow lighting system.

### BACKGROUND INFORMATION

Prior art LED grow light designs utilize commercially available “off the shelf” light sources including LEDs in an attempt to simulate natural sunlight for purposes of growing plants indoors or out of natural sunlight. Such prior art LED grow lights, however, typically consume a significant amount of energy and produce a significant amount of heat. In addition, the prior art grow lights suffer from lackluster performance, longevity issues, and non-serviceability, all problems solved by the LED grow lighting system of the present invention.

### SUMMARY OF THE INVENTION

The present invention overcomes the prior art problems by applying the latest innovations in new emitter technology, newest concepts in voltage, current & wattage considerations, and the latest advancements in heat elimination/dissipation methodologies. The unique design employed within the system of the present invention positively maintains overall lower operating temperature without the required bulky heat sinks, energy robbing fans, or liquid heat radiation techniques used in prior art solid state fixtures. The present invention's unique temperature abatement system eliminates prior art steel fasteners and promotes nylon quick assembly push rivets (NR) to structurally secure each Emitter Array (EA) to the Modular Array Strip (MAS) and also to secure each MAS to the Main Housing (MH). Usage of the NR promote simple and easy assembly and serviceability not common in prior art fixtures. Full assembly and all component replacement is accomplished using common hand tools. As a 100% serviceable lighting product, the SSEGL prevents fixture obsolescence. This significantly improves the value of the grower's investment and reduces ever growing landfill issues.

The Solid State Emitter Grow Light (SSEGL) according to the present invention is specifically designed to implement unique technical and engineering advancements to resolve lackluster performance, longevity issues, and non-serviceability presently experienced in prior art solid state and non-solid state grow light fixtures employed throughout the expansive global grow industries. Each technological enhancement featured within the SSEGL design of the present invention is described as follows.

Taking into account the numerous negative aspects of all prior art forms of grow lights including prior art LED models and various prior art high wattage heat producing 600, 1,000 & 2,000 watt grow lamps (or bulbs) including MV, HID, HPS and others, the SSEGL systematically addresses each undesirable trait including heat, weight, longevity and non-serviceable issues found in prior art designs.

### BRIEF DESCRIPTION OF THE DRAWINGS

These and other features and advantages of the present invention will be better understood by reading the following detailed description, taken together with the drawings wherein:

FIG. 1 is an exploded view of a solid state emitter grow light according to the present invention;

FIG. 2 is an exploded end view of how an emitter array and modular array strip to the main housing using a nylon fastener according to one feature of the present invention;

FIG. 3 is an illustration of a number of solid state arrays mounted on a PC board according to another feature of the present invention;

FIGS. 4A-4C illustrate solid state emitter grow light assemblies of varying sizes according to yet another feature of the invention; and

FIGS. 5, 6 and 7A and 7B are photos which illustrate top, bottom and perspective views of assembled solid state emitter grow light systems according to the present invention.

### DETAILED DESCRIPTION OF THE PREFERRED EMBODIMENTS

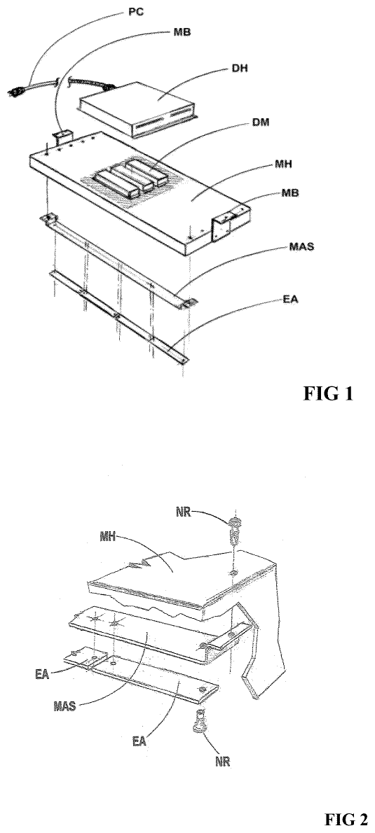

The SSEGL (Solid State Emitter Grow Light) design according to the present invention consists of a low-profile lightweight main housing (MH), FIG. 1, which provides secure attachment and positioning of each (one or more) individual modular array strips (MAS). Each required emitter array (EA) is solidly secured to each MAS.

Unlike prior art LED grow light designs utilizing commercially available “off the shelf” light sources in attempts of dialing in natural sunlight, the SSEGL design of the present invention precisely obtains these objectives by applying the latest innovations in new LED emitter technology, newest concepts in voltage, current & wattage considerations, and the latest advancements in heat elimination methodologies. The unique, proprietary EA design employed within the SSEGL of the invention positively maintains overall lower operating temperature without the required bulky heat sinks, energy robbing fans, or liquid heat radiation techniques used in prior art solid state fixtures.

The SSEGL unique temperature abatement system eliminates prior art steel fasteners and promotes nylon quick assembly push rivets (NR) FIG. 2 to structurally secure each EA to the MAS and also to secure each MAS to the MH. Usage of the NR promotes simple and easy assembly and serviceability not common in prior art fixtures. Full assembly and all component replacement is accomplished using common hand tools. As a 100% serviceable lighting product, the SSEGL according to the invention prevents fixture obsolescence. This significantly improves the value of the grower's investment and reduces ever growing landfill issues.

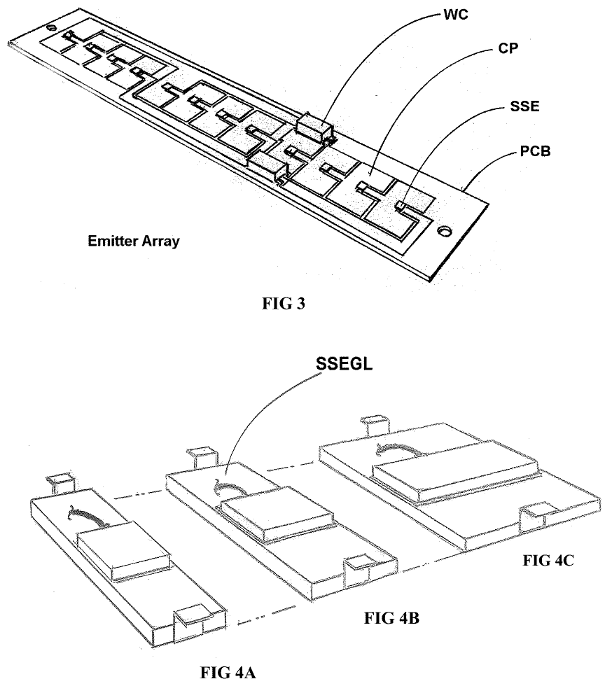

Each Emitter Array (EA) FIG. 3 is constructed to enhance the emitter manufacturer's heat dissipation specifications. Each array contains multiple (for example twelve 12) solid state emitters (SSE) manufactured, for example, by Lumileds Corporation and two easy connect/disconnect wire connectors (WC) manufactured by WAGO Corporation on a printed circuit board (PCB) of industry standard FR4 material. For exemplary purposes, Lumileds part numbers used successfully are L130-5780003000W21, L130-2780003000W21, and L130-2280003000W21, each a different color spectrum, in the ratio of 4-6-2 respectively to achieve the desired full spectrum mimicking of natural sunlight.

The solid state emitters (SSE) of the invention each have a unique voltage to current ratio of six (6) Volts DC voltage drop to one hundred twenty (120) mA of current draw as set by the manufacturer. In comparison, prior art horticultural LEDs have approximately half the voltage drop and double or more the current draw. Each SSE therefore uses less than one (1) watt of power compared to three (3) to ten (10) watts used by the prior art LEDs. As current is the working component and heat producer of this ratio, the SSE of the present invention reduces the amount of heat generated by the component. This allows the PCB to radiate the generated heat sufficiently via the copper pad (CP) connected to the cathode of the SSE per the manufacturer's specifications. The prior art competition's LEDs require metal core PCBs, heat sinks, and cooling fans to prevent premature failure of the LEDs.

Driver Modules (DM), reduce the internal wiring required for each DM plus permit efficient component cooling through natural free air convection. The main housing MH and the drive housing DH are aluminum fabrications with durable powder coat finish. The MH provides the mounting surface for the DH and the DH provides structural rigidity to MH. Once assembled, the two housings, MH and DH, create a fixture profile less than four (4) inches in height. Internal wires are connected using state of the art WAGO lever connectors further advancing the common tool assembly and serviceability design.

SSEGL end user installation is achieved using unique twin mounting brackets (MB) (see FIG. 1) installed at the ends of the fixture. The light weight of the SSEGL prevents overloading of overhead support structures. The MBs allows for either adjustable, suspended lanyard mounting or hard mounting to a solid surface without heat spatial concerns.

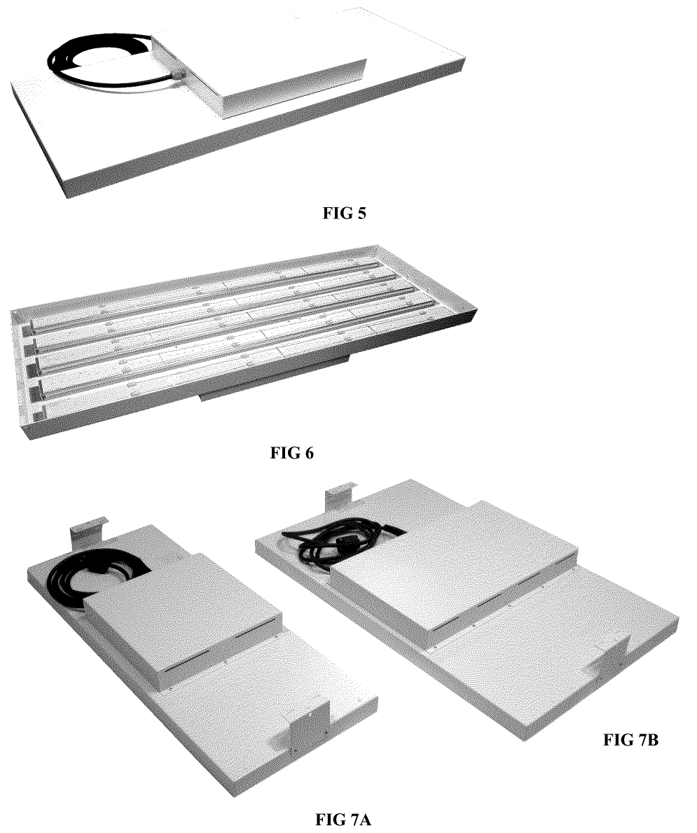

The design of the SSEGL modular assembly system according to the present invention (FIGS. 4A-4C and FIGS. 5-7A and 7B) allows for the creation of various housing sizes (MH & DH) populated with corresponding numbers of common internal components (EA, MAS, DM, & NR). This allows for the assembly of different sizes of grow lights (See FIGS. 4A, 4B and 4C), as required by the grower, to fulfill a particular set of requirements. These requirements are dictated by the size and type of prior art fixtures to be replaced, the size of the grow area, and/or the plants to be grown including the amount of artificial sunlight needed.

Taking into account the numerous negative aspects of all prior art forms of grow lights including prior art LED models and various prior art high wattage heat producing 600, 1,000 & 2,000 watt grow lamps (or bulbs) including MV, HID, HPS and others, the SSEGL according to the present invention is manufactured according to the teachings of the present invention systematically addresses each undesirable trait including heat, weight, longevity and non-serviceable issues found in prior art designs.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A solid state emitter grow light assembly, comprising:
a main housing, configured for providing secure attachment and positioning of one or more individual modular array strips;
a plurality of emitter arrays, each of said plurality of emitter arrays configured for mounting to said one or more individual modular array strips, each of said plurality of emitter arrays including a plurality of solid state light emitters mounted on a printed circuit board, each of said solid state light emitters user selectable to emit light of a desired color spectrum, said printed circuit board including a plurality of copper pads to which a cathode of each solid state light emitter is connected;
a plurality of pushed pin fasteners, configured for securing each emitter array to a modular array strip and each modular array strip to said main housing; and
a plurality of driver modules, each of said plurality of driver modules coupled to and configured for energizing one or more of said plurality of solid state light emitters.
